(19) United States
(12) Patent Application Publication
(10) Pub. No.: US 2024/0282147 A1
(43) Pub. Date: Aug. 22, 2024

(54) ACTION RECOGNITION METHOD, ACTION RECOGNITION DEVICE, AND NON-TRANSITORY COMPUTER READABLE RECORDING MEDIUM

(71) Applicant: Panasonic Intellectual Property Corporation of America, Torrance, CA (US)

(72) Inventors: Nobuhiko WAKAI, Tokyo (JP); Shigehiro IIDA, Tokyo (JP)

(73) Assignee: Panasonic Intellectual Property Corporation of America, Torrance, CA (US)

(21) Appl. No.: 18/650,540

(22) Filed: Apr. 30, 2024

Related U.S. Application Data
(63) Continuation of application No. PCT/JP2022/023524, filed on Jun. 10, 2022.

(30) Foreign Application Priority Data
Nov. 5, 2021 (JP) 2021-181055

(51) Int. Cl. G06V 40/20; G06V 20/70

(52) U.S. Cl. CPC G06V 40/23; G06V 20/70

(57) ABSTRACT

An action recognition device estimates a plurality of nodes of a user and reliability of each of the nodes from an image captured by a camera, extracts, from the estimated nodes, a predetermined detectable node which is detectable by the camera, determines one or more candidate actions from a plurality of target actions by comparing reference reliability of a detectable node predetermined for each of the target actions with reliability of the extracted detectable node, determines an action of the user from the one or more candidate actions, and outputs an action label indicating the determined action.

### FIELD OF INVENTION

This disclosure relates to a technology of recognizing an action of a user from an image.

### BACKGROUND ART

Patent Literature 1 discloses a technology of detecting a person region including a person from an image, estimating a posture type of the person seen in the detected person region and an object type of an object around the person, and recognizing an action of the person from a combination of the posture type and the object type for the purpose of recognizing the action with high accuracy while avoiding an increase in a processing load.

Patent Literature 2 discloses a technology of synthesizing an action score of a person recognized from skeleton information about the person extracted from image data and an action score of the person recognized from an enclosed region of the skeleton information, and outputting the synthesized score for the purpose of recognizing an action of the person with high accuracy while avoiding an influence of image regions except for the image of the person.

However, each of the conventional action recognition technologies as described above is based on the premise of capturing an image of a whole body of a user at a preferable position and a preferable angle of a camera, and thus has a drawback of failure to recognize, with high accuracy, an action of the user from an image not covering the whole body.
Patent Literature 1: Japanese Unexamined Patent Publication No. 2018-206321
Patent Literature 2: Japanese Unexamined Patent Publication No. 2019-144830

### SUMMARY OF THE INVENTION

This disclosure has been achieved to solve the drawback described above, and has an object of providing a technology of recognizing, with high accuracy, an action of a user even from an image not covering a whole body of the user.

An action recognition method according to an aspect of this disclosure is an action recognition method for an action recognition device that recognizes an action of a user, by a processor included in the action recognition device, including: acquiring an image of the user captured by an image capturing device; estimating a plurality of nodes of the user and reliability of each of the nodes from the image; extracting, from the estimated nodes, a predetermined detectable node which is detectable by the image capturing device; determining one or more candidate actions from a plurality of target actions by comparing reference reliability of a detectable node predetermined for each of the target actions with reliability of the extracted detectable node; determining the action of the user from the one or more candidate actions; and outputting an action label indicating the determined action.

This disclosure achieves recognition of an action of a user, with high accuracy, even from an image not covering a whole body.

### BRIEF DESCRIPTION OF THE DRAWINGS

FIG. 1 is a block diagram showing an example of a configuration of an action recognition system in an embodiment of the disclosure.

FIG. 2 is a diagram showing an example of node information including nodes estimated by an estimation part.

FIG. 3 is a diagram showing a configuration of a database storage part in detail.

FIG. 4 shows an example of a data configuration of a first database.

FIG. 5 shows an example of a data configuration of a second database.

FIG. 6 shows an example of a data configuration of a third database.

FIG. 7 is a flowchart showing an example of a process by an action recognition device in the embodiment of the disclosure.

FIG. 8 is a flowchart showing an example of determination of an action label.

FIG. 9 shows an example of an image of a user in an action, the image being captured by a camera.

### DETAILED DESCRIPTION

### Knowledge Forming the Basis of the Present Disclosure

In recent years, a way of estimating a node of a person from an image and recognizing an action of the user on the basis of the estimated node has been known. The aforementioned recognition way includes estimating the node by using a deep neural network including a convolutional layer and a pooling layer to achieve high accuracy.

The deep neural network is designed to calculate node coordinates respectively for a plurality of predetermined nodes, and therefore, a coordinate of a node even not seen in an image and thus having low reliability is also calculated. Recognition of an action of the user by using the coordinate of the node having the low reliability rather results in decreasing recognition accuracy.

The conventional recognition way is based on the premise of use of an image: captured at a camera angle favorable to sensing; and covering the whole body of the user. Specifically, the conventional recognition way fails to suppose estimation of an action from an image not covering a part of the body of the user that is hidden by other object or that is out of the image. Hence, the conventional recognition way has a drawback of failure to recognize an action of the user with high accuracy as a result of recognizing the action of the user from an image not covering the whole body of the user by using even a coordinate of a node having low reliability calculated with the deep neural network. In particular, this drawback is likely to be seen in a house due to a restriction on an arrangement position of the camera. Therefore, the conventional recognition way is unsatisfactory for recognizing the action of the user in the house.

This disclosure has been conceived to solve the drawback described above, and has an object of providing a technology of recognizing an action of a user, with high accuracy, even from an image not covering a whole body of the user.

An action recognition method according to an aspect of this disclosure is an action recognition method for an action recognition device that recognizes an action of a user, by a processor included in the action recognition device, including: acquiring an image of the user captured by an image capturing device; estimating a plurality of nodes of the user and reliability of each of the nodes from the image; extracting, from the estimated nodes, a predetermined detectable node which is detectable by the image capturing device; determining one or more candidate actions from a plurality of target actions by comparing reference reliability of a detectable node predetermined for each of the target actions with reliability of the extracted detectable node; determining the action of the user from the one or more candidate actions; and outputting an action label indicating the determined action.

According to this configuration, a detectable node which is detectable by the image capturing device among the nodes estimated from the image is extracted, and a candidate action is estimated by comparing reliability of the detectable node with the reference reliability. Therefore, the action of the user is determinable by excluding a node which is undetectable by the image capturing device, and the action of the user is recognizable, even from an image not covering the whole body, with high accuracy.

In the action recognition method, the action may include an action of the user using an appliance or equipment arranged in a facility.

This configuration achieves recognition of the action of the user using the appliance or equipment with high accuracy.

In the action recognition method, the equipment may include a rod for assisting a motion of the user, and the appliance may include a stand or a chair for assisting a motion of the user.

This configuration achieves, with high accuracy, recognition of the action of the user, like the walk thereof using the rod, the stand, or the chair assisting the motion of the user.

In the action recognition method, in the determining of the action, in connection with each of the one or more candidate actions, a distance between a coordinate of the extracted detectable node and a reference coordinate of the detectable node may be calculated for each of the target actions, and the action may be determined on the basis of the distance calculated for each of the target actions.

This configuration succeeds in determining, with high accuracy, the action of the user from the one or more candidate actions.

In the action recognition method, in the determining of the action, each of the one or more candidate actions may be determined to be the action.

According to this configuration, the candidate action is directly determinable as the action of the user.

In the action recognition method, in the determining of the one or more candidate actions, a similarity between a distribution of reliability of a plurality of detectable nodes and a distribution of reference reliability of the detectable nodes may be calculated for each of the target actions, and the one or more candidate actions may be determined on the basis of the similarity calculated for each of the target actions.

It is supposed that reliability estimated from an image for a detectable node whose reliability is not inherently high due to an arrangement environment of the image capturing device decreases, and contrarily, reliability estimated from the image for a detectable node whose reliability is high increases. Moreover, this tendency varies for each of the target actions.

According to this configuration, each candidate action is determined on the basis of the similarity between the distribution of the reliability of the detectable nodes estimated from the image and the distribution of the reference reliability of the detectable nodes. From this perspective, the similarity increases when low reliability is obtained for a detectable node whose reliability is inherently low due to an arrangement position of the image capturing device and a target action, and thus, an action of the user is determinable from among the target actions with high accuracy.

In the action recognition method, the similarity may represent a total value of respective differences between the reliability and the reference reliability calculated for each of the detectable nodes.

According to this configuration, the similarity between the distribution of the reliability of the detectable nodes estimated from the image and the distribution of the reference reliability of the detectable nodes is accurately calculatable.

In the action recognition method, the reference reliability may include true reliability given to a detectable node having preliminarily estimated reliability exceeding a threshold, and false reliability given to a detectable node having preliminarily estimated reliability falling below the threshold. The action recognition method may further include: giving the true reliability to a detectable node whose reliability estimated from the image exceeds the threshold, and giving the false reliability to the detectable node whose reliability estimated from the image falls below the threshold. The similarity may be based on the number of values of reliability where truth of the reliability and truth of the reference reliability agree with each other, and false of the reliability and false of the reference reliability agree with each other on each of the detectable nodes.

According to this configuration, the similarity between the distribution of the reference reliability including the preliminarily estimated true reliability and the preliminarily estimated false reliability, and the distribution of the reliability estimated from the image is accurately calculatable.

In the action recognition method, in the determining of the one or more candidate actions, a target action in a top N-th similarity, where “N” is an integer equal to or greater than one, may be determined to be each of the one or more candidate actions.

According to this configuration, a target action having the high similarity is determinable as a candidate action.

In the action recognition method, the node and the reliability may be estimated by inputting the image into a learned model obtained through machine learning of a relation between the image and the node.

According to this configuration, the node is accurately estimative from the image.

In the action recognition method, in the extracting of the detectable node, the detectable node may be extracted with reference to a first database defining information indicating whether each of the nodes represents the detectable node.

According to this configuration, the detectable node is promptly extractable.

In the action recognition method, in the determining of the one or more candidate actions, the one or more candidate actions may be determined with reference to a second database defining the reference reliability of the detectable node for each of the target actions.

This configuration succeeds in promptly acquiring the reference reliability of the detectable node for each of the target actions, and therefore can readily determine the one or more candidate actions.

In the action recognition method, in the determining of the action, the action may be determined with reference to a third database defining a reference coordinate of the detectable node for each of the target actions.

This configuration succeeds in promptly acquiring the reference coordinate of the detectable node for each of the target actions, and therefore can readily determine the action.

In the action recognition method, the detectable node may be preliminarily determined on the basis of a result of analysis of the image of the user captured by the image capturing device at an initial setting.

According to this configuration, the detectable node is specifiable in consideration of capturability of the user by the image capturing device in accordance with the arrangement environment thereof.

In the action recognition method, the reference reliability may be preliminarily calculated on the basis of the reliability of each node estimated from an image of the user having made each of the target actions, the image being captured by the image capturing device at an initial setting.

According to this configuration, the reference reliability is calculatable for each of the target actions in consideration of the capturability of the user by the image capturing device in accordance with the arrangement environment thereof.

In the action recognition method, the reference coordinate may be preliminarily calculated on the basis of a coordinate of each of the nodes estimated from an image of the user having taken each of the target actions, the image being captured by the image capturing device at an initial setting.

According to this configuration, the reference coordinate of the node for each of the target actions is calculatable in consideration of the capturability of the user by the image capturing device in accordance with the arrangement environment thereof.

An action recognition device according to another aspect of this disclosure is an action recognition device that recognizes an action of a user. The action recognition device includes: an acquisition part that acquires an image of the user captured by an image capturing device; an estimation part that estimates a plurality of nodes of the user and reliability of each of the nodes from the image; an extraction part that extracts, from the estimated nodes, a predetermined detectable node which is detectable by the image capturing device; a determination part that determines one or more candidate actions from a plurality of target actions by comparing reference reliability of a detectable node predetermined for each of the target actions with reliability of the extracted detectable node; and an output part that outputs an action label indicating the determined action.

With this configuration, it is possible to provide an action estimation device that exerts operational effects equivalent to those of the action recognition method described above.

An action recognition program according to further another aspect of the disclosure is an action recognition program for causing a computer to execute an action recognition method for recognizing an action of a user, by the computer, including: acquiring an image of the user captured by an image capturing device; estimating a plurality of nodes of the user and reliability of each of the nodes from the image; extracting, from the estimated nodes, a predetermined detectable node which is detectable by the image capturing device; determining one or more candidate actions from a plurality of target actions by comparing reference reliability of a detectable node predetermined for each of the target actions with reliability of the extracted detectable node; determining the action of the user from the one or more candidate actions; and outputting an action label indicating the determined action.

With this configuration, it is possible to provide an action estimation program that exerts operational effects equivalent to those of the action recognition method described above.

This disclosure can be realized as an action estimation system caused to operate by the action estimation program as well. Additionally, it goes without saying that the computer program is distributable as a non-transitory computer readable storage medium like a CD-ROM, or distributable via a communication network like the Internet.

An embodiment which will be described below represents a specific example of the disclosure. Numeric values, shapes, constituent elements, steps, and the order of the steps described below in each embodiment are mere examples, and thus should not be construed to delimit the disclosure. Moreover, constituent elements which are not recited in the independent claims each showing the broadest concept among the constituent elements in the embodiments are described as selectable constituent elements. The respective contents are combinable with each other in the embodiment.

### Embodiment

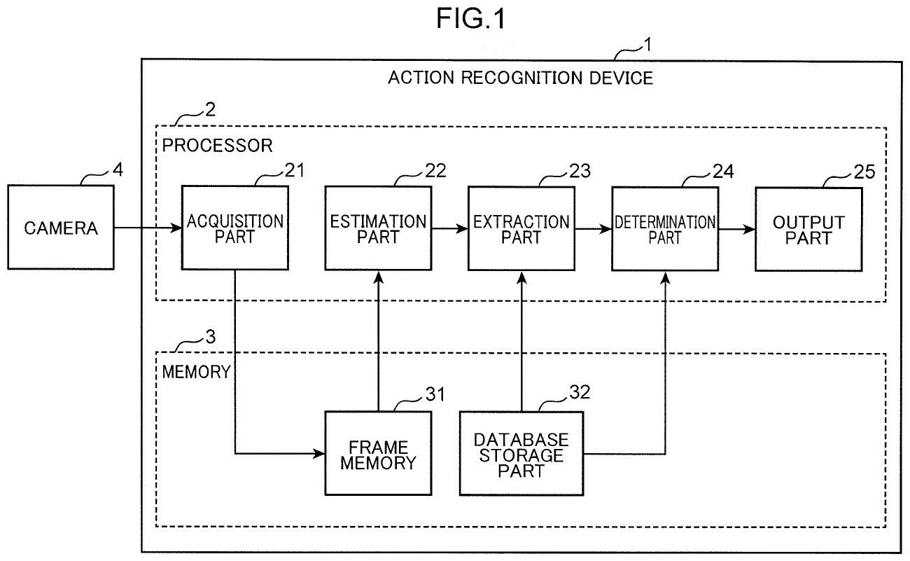

Hereinafter, an embodiment of the disclosure will be described with reference to the accompanying drawings. FIG. 1 is a block diagram showing an example of a configuration of an action recognition system in an embodiment of the disclosure. The action recognition system includes an action recognition device 1 and a camera 4. The camera 4 is an example of an image capturing device. The camera 4 is a fixed camera arranged in a house where a user to be recognized for an action thereof lives. The camera 4 captures an image of the user at a predetermined frame rate, and inputs the captured image to the action recognition device 1 at a predetermined frame rate.

The action recognition device 1 is configured by a computer including a processor 2, a memory 3, and an interface circuit (not shown). The processor 2 includes, for example, a central processing unit. The memory 3 includes a non-volatile storage device, e.g., a flash memory, a hard disk drive and a solid state drive. The interface circuit includes, for example, a communication circuit.

The action recognition device 1 may include an edge server provided in the house, may include a smart speaker provided in the house, or may include a cloud server. When the action recognition device 1 includes the edge server, the camera 4 and the action recognition device 1 are connected to each other via a local area network. When the action recognition device 1 includes a cloud server, the camera 4 and the action recognition device 1 are connected to each other via a wide area network like the internet. Here, a part of the action recognition device 1 may be provided on the edge server, and the remaining part thereof may be provided on the cloud server.

The processor 2 has an acquisition part 21, an estimation part 22, an extraction part 23, a determination part 24, and an output part 25. Each of the acquisition part 21 to the output part 25 may come into effect when the central processing unit executes the action recognition program, or may be established in the form of a dedicated hardware circuit, such as an ASIC.

The acquisition part 21 acquires an image captured by the camera 4 and stores the acquired image in a frame memory 31.

The estimation part 22 estimates a plurality of nodes of the user and reliability of each of the nodes from the image read out from the frame memory 31. The estimation part 22 estimates each of the nodes and the reliability thereof by inputting the image into a learned model obtained through machine learning of a relation between the image and the node. An example of the learned model is a deep neural network. An example of the deep neural network is a convolutional neural network including a convolutional layer and a pooling layer. The estimation part 22 may include a leaning model other than the deep neural network.

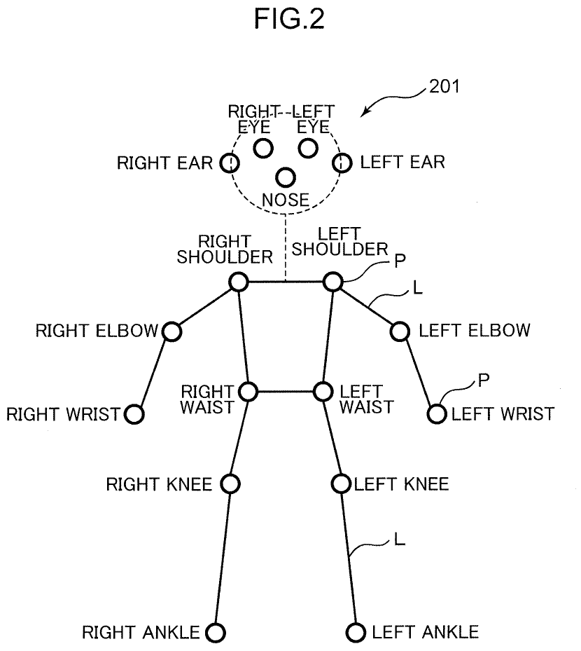

FIG. 2 shows an example of node information 201 including nodes P estimated by the estimation part 22. The node information includes information about nodes P of one person. The node information 201 includes, for example, seventeen nodes P consisting of a left eye, a right eye, a left ear, a right ear, a nose, a left shoulder, a right shoulder, a left waist, a right waist, a left elbow, a right elbow, a left wrist, a right wrist, a left knee, a right knee, a left ankle, and a right ankle. Specifically, the estimation part 22 is configured to estimate the seventeen nodes P. The node information 201 further includes links L linking the nodes P to each other. In FIG. 2, dot lines represent auxiliary lines respectively denoting an outline of a face and a location of a neck. Each node P is expressed on an X-coordinate and a Y-coordinate denoting the position on the image. The node information 201 is expressed by an indicator uniquely specifying each node P, the coordinate of the node P, and reliability of the node P. For instance, the node information 201 is expressed in the following dictionary-like format: {an indicator “right eye”: [X-coordinate, Y-coordinate, reliability], an indicator “left eye”: [X-coordinate, Y-coordinate, reliability], . . . an indicator “left ankle”: [X-coordinate, Y-coordinate, reliability]}.

The reliability is estimated by the estimation part 22 for each node P. The reliability expresses certainty of the estimated node P at a probability. As a value of the reliability increases, the certainty increases. The reliability takes a value of, for example, “0” or larger and “1” or smaller. In the example shown in FIG. 2, the node information 201 includes the seventeen nodes P, but this is a mere example. The number of nodes P may be sixteen or smaller, or may be eighteen or larger. In this case, the learned model may be configured to estimate a predetermined number of nodes P that is sixteen or smaller, or eighteen or more. Furthermore, the node information 201 may include other nodes (e.g., nodes of a finger, a mouth, and other parts) in addition to the nodes P shown in FIG. 2.

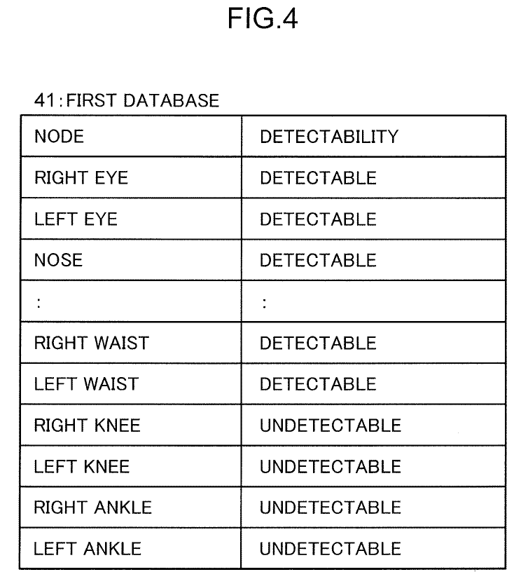

The extraction part 23 extracts a predetermined detectable node which is detectable by the camera 4 from the nodes P estimated by the estimation part 22. For instance, the extraction part 23 extracts a detectable node with reference to a first database 41 (FIG. 4) to be described later.

The determination part 24 determines one or more candidate actions from a plurality of target actions by comparing reference reliability of a predetermined detectable node for each of the target actions with reliability of the detectable node extracted from the image. The determination part 24 further determines an action of the user from the one or more candidate actions. The target actions are defined in advance. Examples of the target actions include an action of the user using an appliance or equipment arranged in the house by the user. An example of the equipment is a rod (e.g., a handrail) for assisting a motion of the user, and an example of the appliance is a stand or chair for assisting a motion of the user.

Examples of the target actions include an action of holding the handrail and an action of standing up from the chair while holding the handrail. These are mere examples, and the target actions include various actions supposed to be taken by the user in the house. For instance, the target action may be an action of cooking. Examples of the action of cooking include tossing a frying pan, using a kitchen knife, and opening and closing a door of a refrigerator. The target actions may include an action of doing the laundry and an action of cleaning. Examples of the action of doing the laundry include putting the laundry in a washing machine and taking out the laundry from the washing machine to dry them out. Examples of the action of cleaning include using a cleaner and using a dust cloth. Moreover, the target actions may include an action of taking a meal. Furthermore, the target actions may include an action of lying on a bed, an action of getting up from the bed, an action of watching a television, an action of reading a book, an action of working at a desk, an action of walking, an action of standing up, and an action of sitting.

The memory 3 has the frame memory 31 and a database storage part 32. The frame memory 31 stores an image acquired by the acquisition part 21 from the camera 4.

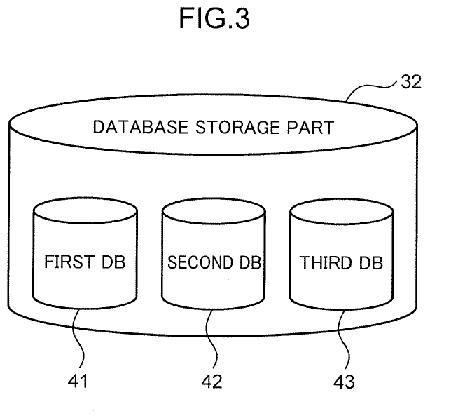

The database storage part 32 stores a database to be used as prior knowledge. FIG. 3 shows a configuration of the database storage part 32 in detail. The database storage part 32 includes the first database 41, a second database 42, and a third database 43.

FIG. 4 shows an example of a data configuration of the first database 41. The first database 41 stores detectability representing information indicating whether each node is a detectable node. Specifically, the first database 41 stores an indicator of each node and the detectability in association with each other. The detectability includes being detectable and being undetectable. A node falling within a capturing range of the camera 4 is detectable. Contrarily, a node being out of the capturing range of the camera 4, and a node falling within the capturing range of the camera 4 but hidden by an obstacle are undetectable. It is seen from the example shown in FIG. 4 that the right eye to the left waist are detectable and the right knee to the left ankle are undetectable. The undetectable nodes are excluded from a later execution with reference to the first database 41. This leads to improvement in the accuracy of recognizing an action.

The first database 41 is created at an initial setting of the action recognition device 1 after arrangement of the camera 4. The camera 4 has a different capturing range depending on each arrangement place thereof, and accordingly, nodes covered in an image captured by the camera 4 vary. Under the circumstances, the first database 41 is created per arrangement of the camera 4. For instance, when the camera 4 is arranged in a place where only an upper body of the user is capturable, the nodes of both the knees and both the ankles are undetectable.

The detectability is predetermined on the basis of a result of analysis of the image of the user captured by the camera 4 at the initial setting. This analysis is made by, for example, a manager who manages the action recognition device 1. The user causes the camera 4 to capture an image thereof and transmits the image to a manager server (not shown) at the initial setting. The manager browses the image received by the manager server to visually analyze which node is detectable and which node is undetectable, and transmits an analysis result to the action recognition device 1. The action recognition device 1 registers the transmitted analysis result in the first database 41. In this manner, the first database 41 shown in FIG. 4 is obtainable. The initial setting is firstly made by the user having introduced the action recognition device 1. Described heretofore is the analysis visually made by the manager, but this is a mere example, and the analysis may be made by a computer through image processing.

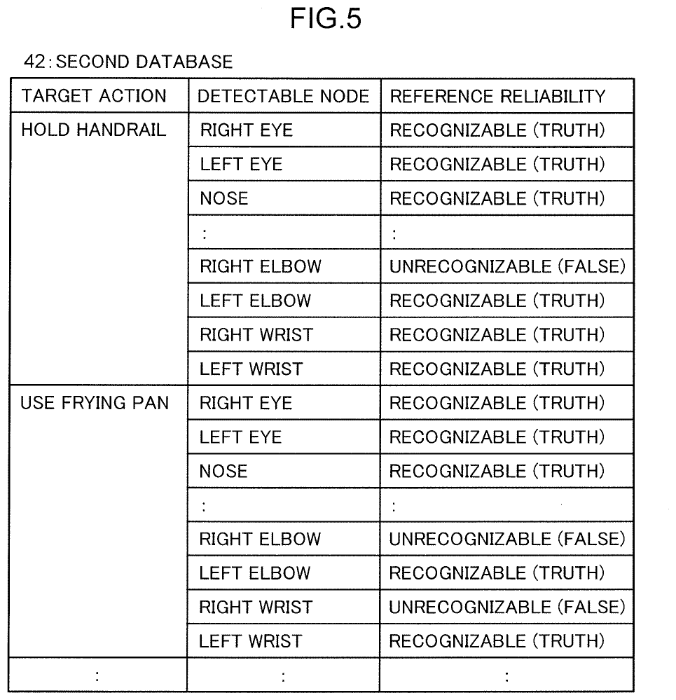

FIG. 5 shows an example of a data configuration of the second database 42. The second database 42 defines reference reliability of a detectable node for each of the target actions. Specifically, the second database 42 stores an indicator of the detectable node and the reference reliability thereof in association with each other for each of the target actions. The reference reliability is preliminarily calculated on the basis of the reliability of each node estimated from an image of the user having taken each of the target actions, the image being captured by the camera 4. Specifically, at the initial setting, the user is requested to sequentially take the target actions so that the camera 4 captures an image of the user for each of the target actions. Moreover, the estimation part 22 estimates reliability of a detectable node on the acquired image, and the reference reliability is determined on the basis of a result of the estimation.

In the example shown in FIG. 5, true reliability indicating a recognizable node is given to a node having reliability exceeding a threshold at the initial setting, and false reliability indicating an unrecognizable node is given to a node having reliability falling below the threshold at the initial setting. The threshold can take, for example, an appropriate value, such as “0.1”, “0.2”, and “0.3”.

The node having the false reliability is captured by the camera 4 but is unlikely to show high reliability when the user takes a specific target action. In the embodiment, regarding such a node as an unrecognizable node leads to an increase in accuracy of recognizing a candidate action. The second database 42 further excludes the nodes of the right knee, the left knee, the right ankle, and the left ankle registered as undetectable in the first database 41 since these nodes are useless for determination of a candidate action.

In the example shown in FIG. 5, a true value and a false value of the reliability are stored, but a value of the reliability may be stored instead.

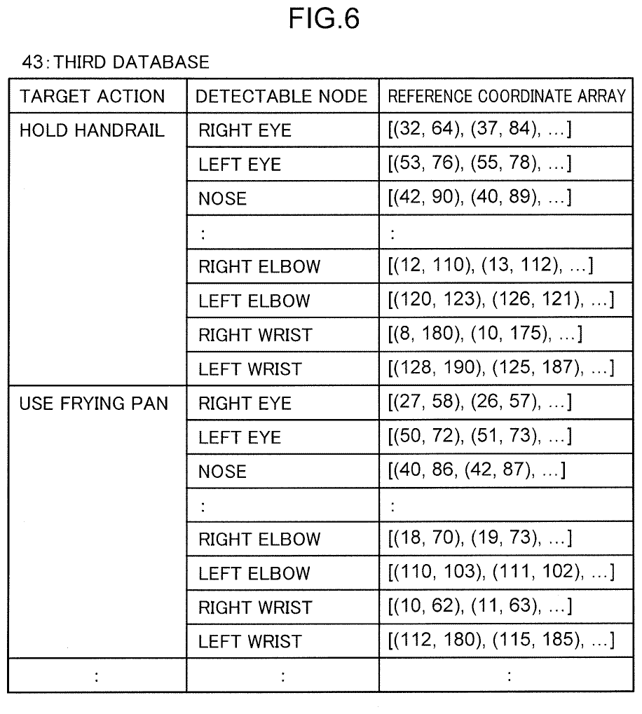

FIG. 6 shows an example of a data configuration of the third database 43. The third database 43 defines a reference coordinate of a detectable node for each of the target actions. Specifically, the third database 43 stores an indicator of the detectable node and a reference coordinate array thereof in association with each other for each target action. The reference coordinate array represents an array of a coordinate of each detectable node estimated from the image of the user having taken a target action at an initial setting, the image being captured by the camera 4. Specifically, at the initial setting, the user is requested to sequentially take a plurality of target actions so that the camera 4 captures an image of the user in a predetermined frame for each of the target actions. Moreover, the estimation part 22 estimates a coordinate of the detectable node from the acquired image, and the estimated coordinate is stored in the third database 43 as the reference coordinate array.

In the example shown in FIG. 6, the reference coordinate array is stored, but a reference coordinate for one frame may be stored. In this case, the reference coordinate for the one frame represents, for example, an average value of coordinates of detectable nodes in a plurality of frames. The reference coordinate may be a relative coordinate based on the centroid of a node coordinate. Further, the reference coordinate may be a coordinate of a node estimated from an image of an unspecified user and obtained in advance.

The third database 43 excludes the nodes of the right knee, the left knee, the right ankle, and the left ankle registered as undetectable in the first database 41 since these nodes are useless for determination of an action.

The action recognition device 1 may not be necessarily realized by a single computer device, but may be realized by a decentralization system (not shown) including a terminal device and a server. In this case, the acquisition part 21, the frame memory 31, and the estimation part 22 may be provided in the terminal device, and further, the database storage part 32, the determination part 24, and the output part 25 may be provided in the server. In this case, the constituent elements transfer data therebetween via a wide area network.

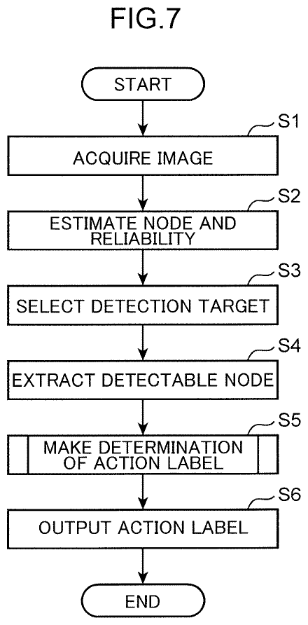

Heretofore, the configuration of the action recognition device 1 is described. Next, a process by the action recognition device 1 will be described. FIG. 7 is a flowchart showing an example of the process by the action recognition device 1 in the embodiment of the disclosure.

### Step S1

The acquisition part 21 acquires an image and stores the acquired image in a frame memory 31.

### Step S2

The estimation part 22 acquires the image from the frame memory 31 and estimates a plurality of nodes and reliability of each of the nodes by inputting the acquired image into a learned model. Described here is estimation of an action of the user based on one image for easy explanation, but this is a mere example, and the action of the user may be estimated on the basis of a plurality of images. In this case, each estimated node and reliability form chronological data.

### Step S3

When the image covers a plurality of users, the estimation part 22 selects a user to be recognized from among the users. When a plurality of pieces of node information 201 is obtained in the estimation in step S2, the estimation part 22 may determine that the image covers the plurality of users. When the image does not cover the plurality of users, step 3 is skipped.

The estimation part 22 may select a user having highest reliability from among the users. Alternatively, the estimation part 22 may select a user showing a largest bounding rectangle area including nodes from among the users. Further alternatively, the estimation part 22 may select a user showing a shortest distance between a position of a specific object covered in the image and a reference point like the centroid of a node. An example of the specifin object is a door.

Described here is selection of one user from the plurality of users covered in the image for easy explanation, but actions of the users may be simultaneously estimated, or the actions of the users may be sequentially estimated.

### Step S4

The extraction part 23 extracts a detectable node defined in the first database 41 from among the nodes estimated by the estimation part 22. Here, the nodes of the right eye, the left eye, the nose, . . . , the right waist, and the left waist are extracted as detectable nodes, and the nodes of the right knee, the left knee, the right ankle, and the left ankle are excluded as undetectable nodes with reference to the first database 41.

### Step S5

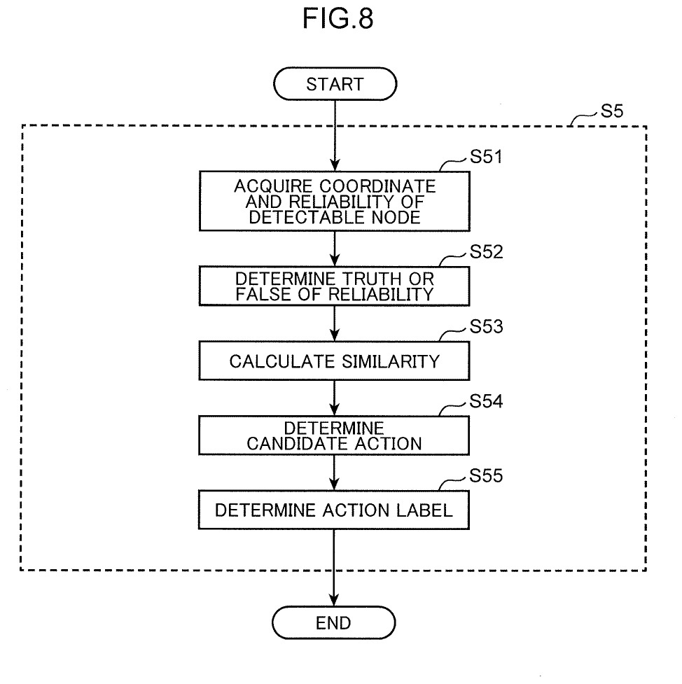

The determination part 24 makes a determination of an action label. The determination of the action label will be described later in detail with reference to FIG. 8.

### Step S6

The output part 25 outputs the action label determined by the determination part 24. An output way for the action label varies in accordance with an action recognition system adopting the action recognition device 1. For instance, in a case where the action recognition system controls an appliance in accordance with an action label, the output part 25 outputs the action label to the appliance. Alternatively, in a case where the action recognition system manages an action of a user, the output part 25 stores a time stamp in the memory 3 in association with the action label.

Subsequently, the determination of the action label in step S5 shown in FIG. 7 will be described in detail. FIG. 8 is a flowchart showing an example of the determination of the action label.

### Step S51

The determination part 24 acquires a coordinate of a detectable node extracted by the extraction part 23, and reliability of the detectable node. Here, a coordinate and reliability of each of the right eye, the left eye, the nose, . . . , the right waist, and the left waist each serving as a detectable node are acquired.

### Step S52

The determination part 24 determines truth or false of the reliability acquired from the extraction part 23. Here, the reliability of each of the right eye, the left eye, the nose, . . . , the right waist, and the left waist each serving as a detectable node is compared with a threshold, and true reliability is given to a detectable node whose reliability exceeds the threshold, and false reliability is given to a detectable node whose reliability falls below the threshold. In this manner, a distribution of reliability of the detectable nodes is obtainable. The threshold can take, for example, an appropriate value, such as “0.1”, “0.2”, and “0.3”.

### Step S53

The determination part 24 calculates a similarity for each target action by comparing a distribution of the reference reliability defined in the second database 42 with the distribution of the reliability of each detectable node obtained in step S52 for each target action. Hereinafter, calculation of the similarity will be described.

First, the distribution of the reliability calculated in step S52 is defined as a set A of true values and false values, and the distribution of the reference reliability is defined as a set B of true values and false values. Moreover, a set indicating agreement or disagreement between true values of detectable nodes common in the set A and the set B and between false values of detectable nodes common in these sets is defined as a set C. The set C is expressed below by using exclusive disjunction. Besides, the number of true values in the set C results in showing a similarity.

$$C = not ( A XOR B ’ )$$

It is noted here that the sign B′ denotes a true or false value in the set B about one detectable node selected from the set A. As the number of true elements included in the set C is larger, an agreement rate between the distribution of reliability and the target action label increases. For instance, the set A is defined to include {right eye: truth, left eye: false, nose: truth, right shoulder: truth, left shoulder: truth, right waist: truth, left waist: truth, right elbow: false, left elbow: truth, right wrist: truth, left wrist: truth}. The set indicating a target action “HOLD HANDRAIL” registered in the second database 42 is defined as “B”. In this case, all the true values of the common detectable nodes agree with each other, and all the false values of the common detectable nodes agree with each other. Therefore, there are thirteen true values in the set C, and thus the similarity indicates “13”.

By contrast, when the set indicating a target action “USE FRYING PAN” is defined as “B”, the right wrist in the set A having the true value differs from the right wrist in the set B having the false value. Therefore, there are twelve true values in the set C, and thus the similarity indicates “12”. It is seen from these perspectives that the target action “HOLD HANDRAIL” has the similarity higher than the similarity of the target action “USE FRYING PAN”, and hence is highly likely to be determined as a target action belonging to the set A.

As described heretofore, in the embodiment, false reference reliability is given to a detectable node whose reliability is not inherently high due to the arrangement environment of the camera 4. Besides, reliability of the detectable node estimated from an image is also supposed to be low. Under the circumstances, the number of true values in the set C is calculated as the similarity in the embodiment. Therefore, it is determinable which target action corresponds to a certain action belonging to the set A.

In the description above, the reliability and the reference reliability are compared with each other on the basis of respective true and false values, but this is a mere example. The reliability and the reference reliability may be compared with each other on the basis of a value of the reliability and a value of the reference reliability. In this case, the determination part 24 may form the set A with the value of the reliability and form the set B with the value of the reference reliability, calculate a difference between the reliability of each detectable node common in the set A and the set B and a difference between the reference reliability of the detectable node common in the sets, and calculate a total value D of the differences as the similarity. Each difference is, for example, an absolute value difference or a squared error. In this case, a target action having a smaller total value D is more highly likely to agree with an action belonging to the set A.

### Step S54

The determination part 24 determines, on the basis of the similarity calculated for each of the target actions, a candidate action among target actions. For instance, when the similarity is expressed with the number of true values in the set C, the determination part 24 may determine, as the candidate action, a target action having the number of true values in the set C that is larger than a reference number. The reference number can take an appropriate value of, for example, five, eight, ten, and fifteen.

Alternatively, when the similarity is expressed with the total value D, the determination part 24 may determine, as the candidate action, a target action having a total value D smaller than a reference total value.

Further alternatively, the determination part 24 may determine, as the candidate action, a target action in a top N-th similarity in descending order of similarities of target actions. The number “N” can take an appropriate value, such as three, four, five, and six.

### Step S55

The determination part 24 determines an action label of the user by comparing the coordinate of the detectable node acquired in step S51 with the reference coordinate defined in the third database 43 for each candidate action determined in step S54.

Referring to FIG. 6, specifically, when the coordinate of the acquired detectable node denotes a coordinate for one frame, the determination part 24 reads out a coordinate corresponding to a reference frame from a reference coordinate array, and calculates a distance between the read-out coordinate and a coordinate of an input detectable node for each detectable node. The distance is, for example, the Euclidean distance. The reference frame may be a leading reference frame, a center frame, or a frame in the predetermined number from the leading frame.

Subsequently, the determination part 24 calculates an average value of distances calculated for respective detectable nodes as an evaluation value. The determination part 24 executes the calculation for each candidate action, and calculates the evaluation value for each candidate action.

Then, the determination part 24 determines, as an action of the user, a candidate action having an evaluation value smaller than a reference evaluation value. The reference evaluation value can take an appropriate value of, for example, ten pixels, fifteen pixels, and twenty five pixels in consideration of a resolution of an image.

When the coordinate of the input detectable node denotes a coordinate for a plurality of frames, the determination part 24 may calculate an average value of distances between corresponding frames for each detectable node, and calculate, as the evaluation value, a value obtained by further averaging the average value of the distances for each calculated detectable node. When the plurality of frames consists of two frames, in the example of the right eye in the target action “HOLD HANDRAIL”, a reference coordinate including (32, 64) and (37, 84) is read out from the reference coordinate array. When the coordinate of the right eye input for the two frames denotes (X1, Y1), (X2, Y2), a distance between (36, 64) and (X1, Y1), and a distance between (37, 84) and (X2, Y2) are calculated, and an average of the distances results in an average distance of the right eye in the target action “HOLD HANDRAIL”. An average value of the distances is calculated for another detectable node in the target action “HOLD HANDRAIL”, and a value obtained by further averaging the calculated average value of the distances results in an evaluation value of the target action “HOLD HANDRAIL”.

It is noted here that a coordinate of a detectable node may be defined as a feature vector and the feature vector may be input into the learned model to calculate the evaluation value of each candidate action. The learned model includes a support vector machine or a deep neural network.

When there is no candidate action having an evaluation value lower than the reference evaluation value among the candidate actions, the determination part 24 may define a result of the determination of the action label as another action.

Alternatively, when there is a plurality of candidate actions each having an evaluation value lower than the reference evaluation value, the determination part 24 may determine a candidate action having the smallest evaluation value as an action label of the user. Further alternatively, when there is a plurality of candidate action each having an evaluation value lower than the reference evaluation value, the determination part 24 may arrange candidate actions in ascending order of evaluation values, and determine each candidate action in the order as an action label of the user to be output.

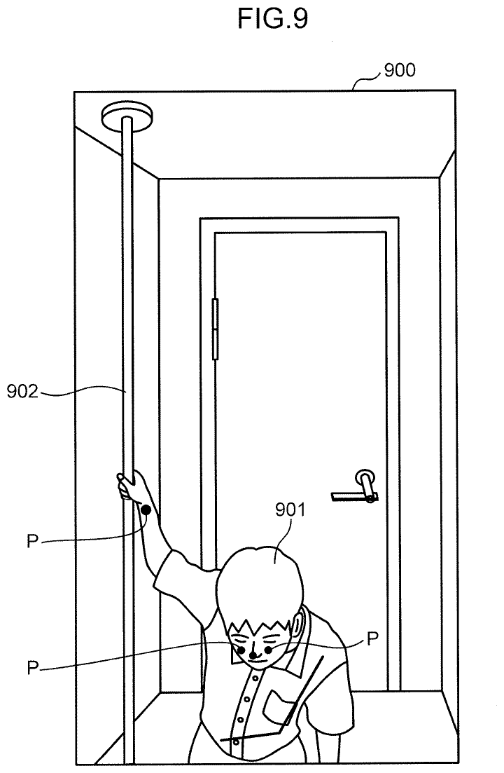

FIG. 9 shows an example of an image 900 of the user in an action, the image being captured by the camera 4. The image 900 covers a user 901 taking an action of holding a handrail 902 at an entrance hall. The user 901 sits on a chair (not shown) to take off shoes, and raises and extends the right hand to hold the handrail 902 in the rear thereof. The camera 4 is arranged at an angle of looking down the user 901 from the front thereof. The left knee, the right knee, the left ankle, and the right ankle are out of a capturing range of the camera 4, and thus, the first database 41 stores these nodes as undetectable nodes.

Typical actions of the user, such as walking, sitting, and standing up, are generally taken in a posture of lowering the hand, and are less likely to be taken in a posture of raising the hand as shown in the image 900. Hence, the learned model for estimation of a node rarely adopts such an image of a posture of raising a hand as learning data. As a result, when the user takes the posture seen in the image 900, the learned model is highly unlikely to appropriately estimate a node. The learned model may adopt images collected from the internet to execute learning. Even in this case, the learned model is highly unlikely to appropriately estimate a node of the user taking a posture except for the typical standing posture, walking posture, and sitting posture.

Moreover, a node like the elbow or the knee located at a non-end of the body is less detectable than a node like the wrist or the ankle located at an end of the body. Therefore, the image 900 shows a success in detecting the node P of the right wrist and a failure in detecting the node of the right elbow. Here, the nodes P of the right eye, the left eye, and the nose are detected on the image 900.

Actions frequently taken by the user in the house include an action of tossing a frying pan. The action of tossing the frying pan is taken in a posture of raising a hand. As described above, the learned model is less likely to adopt learning of such a posture of raising the hand. Hence, the learned model is highly likely to fail to estimate the node of the right wrist of the right hand holding the frying pan, and the node of the right elbow.

In addition, a node for which estimation is failed varies depending on an arrangement environment of the camera 4 and an action.

Here, the embodiment aims at focusing on variation in a node for which estimation is likely to fail depending on each action, and at determining an action of the user by regarding the node as non-estimative. Specifically, the embodiment aims at distinguishing a node having reliability exceeding a threshold from a node having reliability falling below the threshold for each target action at an initial setting, giving true reliability to a node whose reliability exceeds the threshold, giving false reliability to a node whose reliability falls below the threshold, and causing the second database 42 to store the true reliability and the false reliability as preliminary knowledge. Consequently, an action of the user is recognizable with high accuracy. In particular, the embodiment is useful for recognizing an action of a user in a house having many restrictions on the arrangement position of the camera 4.

### Modification

In step S55 shown in FIG. 8, the determination part 24 may avoid comparing a coordinate of a detectable node with a reference coordinate of a candidate action. In this case, the determination part 24 may directly determine the candidate action determined in step S54 as an action of the user.

An action recognition device according to this disclosure is useful for recognizing an action of a user in a house.

1. An action recognition method for an action recognition device that recognizes an action of a user, by a processor included in the action recognition device, comprising:
acquiring an image of the user captured by an image capturing device;
estimating a plurality of nodes of the user and reliability of each of the nodes from the image;
extracting, from the estimated nodes, a predetermined detectable node which is detectable by the image capturing device;
determining one or more candidate actions from a plurality of target actions by comparing reference reliability of a detectable node predetermined for each of the target actions with reliability of the extracted detectable node;
determining the action of the user from the one or more candidate actions; and
outputting an action label indicating the determined action.

2. The action recognition method according to claim 1, wherein the action includes an action of the user using an appliance or equipment arranged in a facility.

3. The action recognition method according to claim 2, wherein the equipment includes a rod for assisting a motion of the user, and
the appliance includes a stand or a chair for assisting a motion of the user.

4. The action recognition method according to claim 1, wherein, in the determining of the action, in connection with each of the one or more candidate actions, a distance between a coordinate of the extracted detectable node and a reference coordinate of the detectable node is calculated for each of the target actions, and the action is determined on the basis of the distance calculated for each of the target actions.

5. The action recognition method according to claim 1, wherein, in the determining of the action, each of the one or more candidate actions is determined to be the action.

6. The action recognition method according to claim 1, wherein, in the determining of the one or more candidate actions, a similarity between a distribution of reliability of a plurality of detectable nodes and a distribution of reference reliability of the detectable nodes is calculated for each of the target actions, and the one or more candidate actions are determined on the basis of the similarity calculated for each of the target actions.

7. The action recognition method according to claim 6, wherein the similarity represents a total value of respective differences between the reliability and the reference reliability calculated for each of the detectable nodes.

8. The action recognition method according to claim 6, wherein the reference reliability includes true reliability given to a detectable node having preliminarily estimated reliability exceeding a threshold, and false reliability given to a detectable node having preliminarily estimated reliability falling below the threshold, the action recognition method further comprising:
giving the true reliability to a detectable node whose reliability estimated from the image exceeds the threshold, and giving the false reliability to the detectable node whose reliability estimated from the image falls below the threshold, wherein
the similarity is based on the number of values of reliability where truth of the reliability and truth of the reference reliability agree with each other, and false of the reliability and false of the reference reliability agree with each other on each of the detectable nodes.

9. The action recognition method according to claim 6, wherein, in the determining of the one or more candidate actions, a target action in a top N-th similarity, where “N” is an integer equal to or greater than one, is determined to be each of the one or more candidate actions.

10. The action recognition method according to claim 1, wherein the node and the reliability are estimated by inputting the image into a learned model obtained through machine learning of a relation between the image and the node.

11. The action recognition method according to claim 1, wherein, in the extracting of the detectable node, the detectable node is extracted with reference to a first database defining information indicating whether each of the nodes represents the detectable node.

12. The action recognition method according to claim 1, wherein, in the determining of the one or more candidate actions, the one or more candidate actions are determined with reference to a second database defining the reference reliability of the detectable node for each of the target actions.

13. The action recognition method according to claim 1, wherein, in the determining of the action, the action is determined with reference to a third database defining a reference coordinate of the detectable node for each of the target actions.

14. The action recognition method according to claim 1, wherein the detectable node is preliminarily determined on the basis of a result of analysis of the image of the user captured by the image capturing device at an initial setting.

15. The action recognition method according to claim 1, wherein the reference reliability is preliminarily calculated on the basis of the reliability of each node estimated from an image of the user having made each of the target actions, the image being captured by the image capturing device at an initial setting.

16. The action recognition method according to claim 4, wherein the reference coordinate is preliminarily calculated on the basis of a coordinate of each node estimated from an image of the user having taken each of the target actions, the image being captured by the image capturing device at an initial setting.

17. An action recognition device for recognizing an action of a user, comprising:
an acquisition part that acquires an image of the user captured by an image capturing device;
an estimation part that estimates a plurality of nodes of the user and reliability of each of the nodes from the image;
an extraction part that extracts, from the estimated nodes, a predetermined detectable node which is detectable by the image capturing device;
a determination part that determines one or more candidate actions from a plurality of target actions by comparing reference reliability of a detectable node predetermined for each of the target actions with reliability of the extracted detectable node; and
an output part that outputs an action label indicating the determined action.

18. A non-transitory computer readable recording medium storing an action recognition program for causing a computer to execute an action recognition method for recognizing an action of a user, by the computer, comprising:
acquiring an image of the user captured by an image capturing device;
estimating a plurality of nodes of the user and reliability of each of the nodes from the image;
extracting, from the estimated nodes, a predetermined detectable node which is detectable by the image capturing device;
determining one or more candidate actions from a plurality of target actions by comparing reference reliability of a detectable node predetermined for each of the target actions with reliability of the extracted detectable node;
determining the action of the user from the one or more candidate actions; and
outputting an action label indicating the determined action.
